(19) United States
(12) Patent Application Publication
(10) Pub. No.: US 2008/0223410 A1
(43) Pub. Date: Sep. 18, 2008

(54) Cleaning a Plurality of Supply Lines

(75) Inventors: Anthony Molloy, Edgbaston (GB); Steven James Wheeler, Hereford (GB); Matthew Molloy, Wallsend (GB)

Correspondence Address: KING & SCHICKLI, PLLC, 247 NORTH BROADWAY, LEXINGTON, KY, 40507, US

(73) Assignee: CleverClear Ltd, Hereford (GB)

(21) Appl. No.: 10/591,003

(22) PCT Filed: Feb. 8, 2005
(86) PCT No.: PCT/GB2005/000430

§ 371 Date: Nov. 7, 2007

Related U.S. Application Data
(60) Provisional application No. 60/548,458, filed on Feb. 27, 2004.

(30) Foreign Application Priority Data
Feb. 28, 2004 (GB) 0404477.2

(51) Int. Cl. B08B 9/032; B67D 1/07

(52) U.S. Cl. 134/22.11; 134/113; 29/428

(57) ABSTRACT

The fluid supply apparatus includes a plurality of supply lines (308), each line having an outlet control device (328) configurable to either allow or prevent fluid in the line flowing to a shared outlet conduit (326). A controller (332) sets the outlet control devices of one or more of the plurality of supply lines in accordance with the output of a monitoring device (336), which monitors the concentration of cleaning fluid passing through the outlet conduit, to control the fluid delivered by the delivery device and the one or more outlet control devices.

The present invention relates to a cleaning of plurality of supply lines.

Various blockages can cause problems in many types of supply lines. For example, yeast tends to build up inside the lines of apparatus for supplying products that have been through the process of fermentation, e.g. alcoholic beverages such as beer. This can cause the product to fob or become hazy and the quality of the beverage is affected by the in proportion to the quantity of yeast build up in the system. To deal with this problem the lines must be cleaned regularly to produce a satisfactory drink for the consumer. Usually the objective of line cleaning is to maintain a constant state of hygiene, rather than removing yeast after the build up becomes visible. The majority of breweries that supply these yeast based products recommend:
1) That line cleaning is performed every seven days
2) That the cleaning operation is thorough
3) The correct quality and quantity of line cleaning solution is to be used in the cleaning process
4) The storage conditions of the product and cleaning apparatus are satisfactory.

Conventionally, the process of line cleaning is performed manually, with breweries recommending the following procedure:

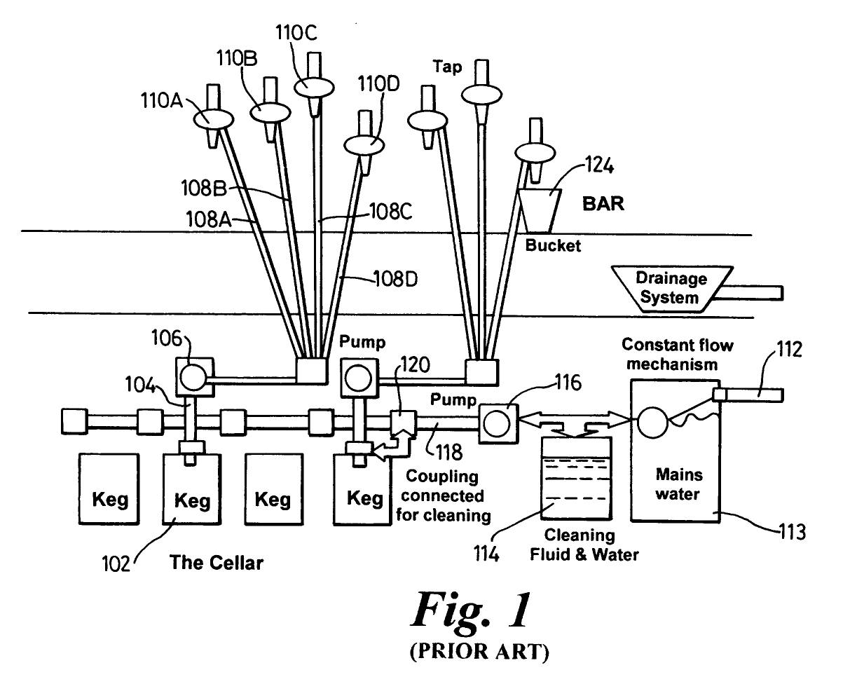

FIG. 1 illustrates schematically a typical set-up for cleaning a beverage supply apparatus. A beer keg 102 is connected to a supply line 104 which leads to a pump 106. The pump 106 is used to deliver beer from the keg 102 in through a glass chamber valve 103. From this gas prevention device 103 the liquid then flows to a set of one up to a maximum of four lines 108A-108D which is in flow communication with the pump 106. The outlet end of each supply line 108A-108D is fitted with a respective tap 110A-110D.
The conventional cleaning apparatus includes a cold water supply outlet 112, which normally runs into a water tank 113. A second tank 114 filled with a mixture of cleaning fluid and water. Fluids from the tank 114 are drawn by a cleaning supply pump 116 into a cleaning fluid conduit 118. A coupling device 120 can be fitted to the beverage supply line 104 to bring it into flow communication with the cleaning fluid supply line 118 when the cleaning process is to be carried out.

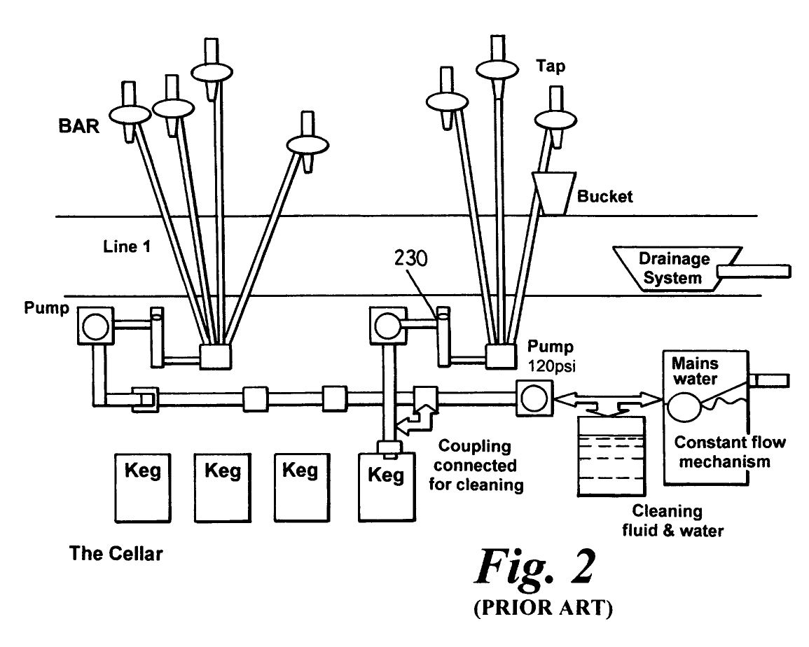

FIG. 2 illustrates another type of existing beverage supply apparatus. The beverage supply apparatus is similar to that of FIG. 1, the main difference being the presence of fluid-only sections of lines such as the components indicated at 230. These components comprise a ball and valve device fitted between the keg 102/pump 106 and the branch adapter of the supply lines 108. The devices are incorporated into the system to prevent air locks forming in the lines and to prevent air flowing from the keg or water mains through the pump into the lines.

Typical steps performed during the cleaning of either conventional beverage supply apparatus may be as follows:
1) Disconnect coupling head 120 from the keg 102 and connect it to the cleaning fluid conduit 118.
2) Complete beer dispensing procedure using the taps 110A-110D on the bar, to allow the beer to flow into a bucket 124.
3) Place the mains water supply outlet 112 into the second tank 114 to produce a mixture of cleaning fluid and water.
4) Use the pump 106 to draw the cleaning fluid and water mixture through the supply lines 104, 108A-108D and open a first tap 110A to allow the fluid to flow into a bucket 124 until the cleaning solution is clearly visible in the bucket.
5) Once the cleaning solution is visible, close the tap 110A and allow the supply lines to steep for at least 10 minutes. Steps 4 and 5 are repeated for each tap 110A-110D on the bar.
6) Once this process is complete, repeat steps 4 and 5 two more times for the taps 110B-110D.
7) Change the outlet 112 from the tank 114 back into the water tank 113.
8) Flush cold water through the supply lines 104, 108A-108D and the taps 110A-110D using the pump 116 to remove the remaining cleaning fluid.
9) Check the fluid flowing from one of the taps with litmus paper.
10) When the litmus paper shows the fluid is neutral (indicating that all the cleaning solution has been flushed from the lines and the tap being tested) disconnect coupling 120 from the line 118 and connect it to the keg 102.
11) Draw beer to one of the taps and check for taste and clarity Other recommendations and safety considerations from breweries can include:
1) Do not leave detergent in the lines for the prolonged periods. If it is left soaking for more than two hours then flavour contamination may occur.
2) Soaking overnight is not recommended, as this will damage the supply lines as well as taint the beer.
3) Cold water should not be left in the beer lines for the same reason.
4) Do not re-use diluted detergent from a previous clean as it rapidly loses its cleaning properties.
5) All members of staff involved in the line cleaning must be aware of, understand and follow the manufacture's Control of Substances Hazardous to Health instructions.
6) Always use protective clothing, goggles and gloves.
7) Always follow the manufacture's safety instructions regarding dilution and handling.
8) Use the plastic cleaning containers supplied by technical services.
9) Add the detergent to water—doing the reverse can result in server burns.
10) Do not mix propriety detergents or exceed the stated dosage or concentration of line cleaner.

There are many associated problems with this manual method of line cleaning. The first problem is the time and effort required for a user to correctly fulfil all of the above 11-point cleaning procedure and the 10 safety and quality recommendations. Second, this recommended cleaning process usually results in wastage of beer present in the lines at the start and end of the cleaning process. Using a bucket to capture the effluent from each individual tap and then having to travel to discard it in a sink is tedious and time-consumer for the user. The correct mixture of cleaning fluid and water is difficult to achieve using this method, and so the cleaning process can vary in safety and quality each time it is performed.

Using a time-based cleaning method is a ‘one size fits all’ solution and is not the most effective solution for an optimal and thorough cleaning process. Variations in performance can result due to the quantity of yeast build-up and the length of the lines in the system. The effectiveness of the cleaning process can vary using these conventional methods, as yeast may still remain in the lines after cleaning. The method relies on a static steeping method to destroy the yeast in the lines.

The running and stopping of the taps at the bar is determined by the personal perception of the user and the use of litmus paper is not very accurate. This can therefore create a variance in the efficiency and effectiveness of the cleaning, and thus affect the quality of the final delivered product.

Existing automated line-cleaning systems are available. However, there is still no guarantee that these systems are fully effective. Existing automated systems are time-dependant to the line cleaning, and there is no automatic indication of whether or not the cleaning process has been effective. This is mainly due to the fact that the cleaning process of any objects is of a variable time activity and not time dependant as in other systems. If cleaning has not been fully effective then the quality of the delivered beverage will suffer. Cleaning economy is also poor using this type of device. Cleaning fluid is not allowed to steep in the system, and is flushed straight out of the system immediately at high pressure and so more cleaning fluid is required to complete the cleaning operation. Further, these conventional automated cannot determine the correct mixture quality of the cleaning fluid. This is because of variances in the volumetric flow rate through the lines due to the yeast build-up but during the cleaning process the volumetric flow rate increases due to the destruction of the yeast (or other restrictions). Therefore the existing solution of delivering cleaning fluid over a predefined, fixed period of time is unreliable.

The existing automated systems may save the beverage in the line for sale by pumping fresh water behind the beer in the line up to the tap on the bar. However, this can affect the quality of the beverages, as it can be watered down and so around two drinks are typically wasted per line each time the cleaning process is performed: one drink at the start of the cleaning operation and one afterwards. These automated systems still require a manual operation to flush the remaining water at the end of the cleaning process through the lines until a servable product is detected by the user at the tap on the bar. Therefore these apparatus are not fully automated as human intervention is required to complete the task, which again can be difficult to manage and time consuming. This can restrict the time of day when these existing automated systems can be operated, i.e. normally only when the staff have enough time to carry out the operation. Finally, the use of cold water in the cleaning process will not destroy bacterial strains in the system, due to the temperature of the cleaning fluid used. This can in turn cause hygiene-related problems.

According to a first aspect of the present invention there is provided a method of cleaning a plurality of supply lines, all or some of the lines having an outlet control device that can be set to either allow or prevent fluid in the line flowing to a shared outlet conduit, the method including steps of:

setting the outlet control devices of one or more of the plurality of supply lines to allow fluid flow to the outlet conduit;

setting the outlet control devices of the remainder of the plurality of supply lines to prevent fluid from flowing to the outlet conduit;

delivering cleaning fluid to the plurality of supply lines such that the fluid passes into the outlet conduit via the one or more outlet control devices so set;

monitoring the concentration of cleaning fluid passing through the outlet conduit, and

ceasing the delivery of cleaning fluid when the concentration reaches a predetermined level.

During the delivery step, cleaning fluid that does not pass into the outlet conduit will steep and be agitated within the supply lines, which can result in an effective cleaning action.

In one embodiment the steps of setting the outlet control devices, delivering the cleaning fluid and monitoring the concentration of cleaning fluid include:

a) setting the outlet control device of a first one of the plurality of supply lines to allow fluid flow to the outlet conduit;

b) setting the outlet control device of the remaining lines to prevent fluid from flowing to the outlet conduit;

c) delivering cleaning fluid to the plurality of supply lines such that the fluid passes into the outlet conduit via the outlet control device for the first line;

d) monitoring the concentration of cleaning fluid passing through into the outlet conduit, and when the concentration reaches a predetermined level;

e) setting the outlet control device of the first line to prevent fluid from flowing to the outlet conduit, and

f) setting the outlet control device of a second one of the plurality of supply lines to allow fluid flow to the outlet conduit.

The steps a) to e) may be repeated for all or some (normally adjacent) pairs of the plurality of supply lines. When all the lines that are to be cleaned have been treated in this way, the delivery of cleaning fluid may be ceased. The method may further include a step of draining the lines to prevent fluid steeping in the system, which can affect the quality of the delivered product.

The step of delivering the cleaning fluid may include opening a flow device that controls flow of cleaning fluid between a cleaning fluid source and the plurality of lines and, normally, pumping, the fluid from the source to the supply lines. The cleaning source flow control device may be set to allow fluid to flow into the lines periodically. For example, the cleaning fluid source flow device may comprise of a valve, with opening of the valve resulting in the fluid flowing to the lines. The outlet control devices may comprise of valves, with opening of the valves resulting in the fluid flowing into the outlet conduit. The one or more outlet valves that are set to allow fluid to flow to the end of the conduit may be opened after the cleaning fluid source is opened such that a phase shift exists between the openings of the valves. The frequency of the openings of the valves may be in the range of 0>f≦10 Hz and the phase shift can vary between the angles of 0>θ<2π radians. Pumping in this way can result in fluid pressure growth and decay within the lines, which may generate differential pressure waves of different phase and magnitude.

The predetermined level of concentration can be substantially equal to the concentration of cleaning fluid supplied from the source, which indicate that no contaminants remain within the lines. The step of monitoring the concentration of the cleaning fluid may include analysing the pH of the fluid passing into the outlet conduit, or other methods such as optical, capacitive, light frequency and/or microscopic methods may be used. For example, in one embodiment the fluid delivery will be ceased if the pH of the fluid is detected to be substantially equivalent to around 12.3 which is a typical pH for the cleaning solution supplied at the start of the process, although it will be appreciated that this condition can vary, e.g. depending upon the type of cleaning fluid used, etc.

The method may include a step of draining at least some of the plurality of lines of any fluid before the cleaning fluid delivery step. This pre-fluid delivery flushing step may be performed using a gas/or liquid.

The method may further include a step of flushing the plurality of lines after ceasing the delivery of cleaning fluid. This post-fluid delivery flushing step may be performed using a gas such as air and/or a liquid such as water. The post-fluid delivery flushing step may include steps of:

delivering water to the plurality of supply lines such that the fluid passes into the outlet conduit via the one or more outlet devices so set;

monitoring the concentration of cleaning fluid passing into the outlet conduit, and

ceasing the delivery of water when the concentration reaches a predetermined minimum level.

The method may further include a step of draining the fluid.

The step of monitoring the concentration may be performed by analysing the pH of the fluid. The water delivery will normally be ceased when the pH of the fluid is detected to be a neutral value of around 7. The cleaning fluid delivered may be supplied from a container. The concentration of cleaning fluid in the container may be kept substantially constant by steps of:

adding a cleaning agent to water to produce a cleaning fluid;

monitoring the concentration of cleaning agent in the cleaning fluid, and

ceasing the adding of the cleaning agent when the concentration reaches a predetermined level. The concentration monitoring may include checking the pH, or the density of fluid using optical methods of the cleaning fluid.

The temperature of the cleaning fluid may be raised, typically to a temperature at which yeast and bacterial strains normally die, e.g. around 50° C. This step can make the cleaning process fast and effective, not just to remove yeast build-ups in the lines, but also to denature any bacterial strains residing in the fluid delivery components/lines. Further, convection currents in the heated fluid can help thoroughly mix water with a cleaning agent.

The method may include a step of modifying the one or more supply lines so that they are in flow communication with a cleaning fluid source instead of a normal source, e.g. a foodstuff or beverage source. This modification may be performed by blocking flow communication between the inlet end of a said supply line (e.g. by means of closing a valve) and adding a coupling/conduit to the line that brings it into flow communication with a conduit through which the cleaning fluid is delivered.

In some embodiments a by-pass conduit may be added to divert fluid past a liquid-only section or through locking open the fluid only valve sections to allow the flow of air (e.g. a section that includes a ball and valve device intended to prevent air locks) of a said supply line to allow both air and liquid to be delivered through the line. Alternatively, a locking device can be adopted to prevent the ball device from closing the valve.

According to a further aspect of the present invention there is provided apparatus including:

a plurality of supply lines, each said line having an outlet control device that can be set to either allow or prevent fluid in the line flowing to a shared outlet conduit;

a cleaning fluid source;

a controller which, in use, can set the outlet control devices of one or more of the plurality of supply Lines;

a device for delivering cleaning fluid from the source to the plurality of supply lines, and

a device for monitoring the concentration of cleaning fluid passing through the outlet conduit,

wherein the controller uses output from the monitoring device to control the fluid delivered by the delivery device and the one or more outlet control devices.

The delivery device may include a pumping device, e.g. a 120 psi pump (or a water mains pressure system), and a device for controlling fluid flow between a cleaning fluid source and the plurality of supply lines. The outlet control devices and/or the cleaning fluid source flow control device may comprise controllable valves such as solenoid valves. In some embodiments, the outlet control devices may include taps (e.g. bar taps) that have been modified or designed to be controlled by the controller.

The cleaning fluid source may include a water source and a cleaning agent source. The apparatus may further include a device for mixing the cleaning agent and water. The apparatus may further include a device for heating the cleaning fluid. The heating device may heat the water that is to be mixed with the cleaning agent.

The outlet conduit may comprise a drainage system or container. The plurality of supply lines may branch from one or more downstream supply lines, and the device for delivering cleaning fluid may be in flow communication (e.g. connected to by means of a coupling) with the one or more downstream supply lines.

The controller may include a display unit for displaying status and/or error messages.

The controller may communicate with the monitoring device and/or the outlet control devices and/or the delivery device by means of one or more of the following: Radio Frequency signals; a ground cable in an alternating current ring mains; conventional writing; Bluetooth™ signals or any other suitable communications system/network.

The apparatus may include a coupling that, in use, is used to bring a said supply into flow communication with a conduit through which the cleaning fluid is delivered.

The apparatus may include one or more devices for checking for failure of any components of the apparatus.

According to another aspect of the present invention there is provided a cleaning kit for apparatus including a plurality of supply lines and a device for delivering cleaning fluid to the supply lines, the kit including:

one or more outlet control devices for use with respective one or more said supply lines, in use, each said outlet control device being set to either allow or prevent fluid in the line flowing to a shared outlet conduit;

a device for monitoring the concentration of cleaning fluid passing through the outlet conduit, and

a controller for setting each said outlet control device;

where, in use, the controller controls the fluid delivery device and the one or more outlet control devices in accordance with output from the monitoring device.

The kit may further include a device for heating the cleaning fluid.

According to yet another aspect of the present invention there is provided a method of installing a cleaning kit for apparatus including a plurality of supply lines and a device for delivering cleaning fluid to the supply lines, the method including steps of:

fitting one or more outlet control devices to a respective one or more said supply lines, in use each said outlet control device being set to either allow or prevent fluid in the line flowing to a shared outlet conduit;

fitting a device for the monitoring the concentration of cleaning fluid passing through the outlet conduit,

fitting a controller which, in use, controls the fluid delivery device and the one or more outlet control devices in accordance with output from the monitoring device.

According to yet another aspect of the present invention there is provided a (beverage/foodstuff) supply apparatus including cleaning apparatus substantially as described herein.

In some cases the existing apparatus does not include the cleaning fluid delivery device and/or the cleaning fluid source and/or the outlet conduit. It will be understood that in such cases the method/kit can be adapted to provide these features.

Whilst the invention has been described above, it extends to any inventive combination of the features set out above or in the following description.

The invention may be performed in various ways, and, by way of example only, embodiments thereof will now be described, reference being made to the accompanying drawings, in which:—

FIG. 1 illustrates schematically a conventional set up for cleaning beverage supply lines;

FIG. 2 illustrates schematically another conventional set up for the cleaning beverage supply lines including an air lock prevention mechanism;

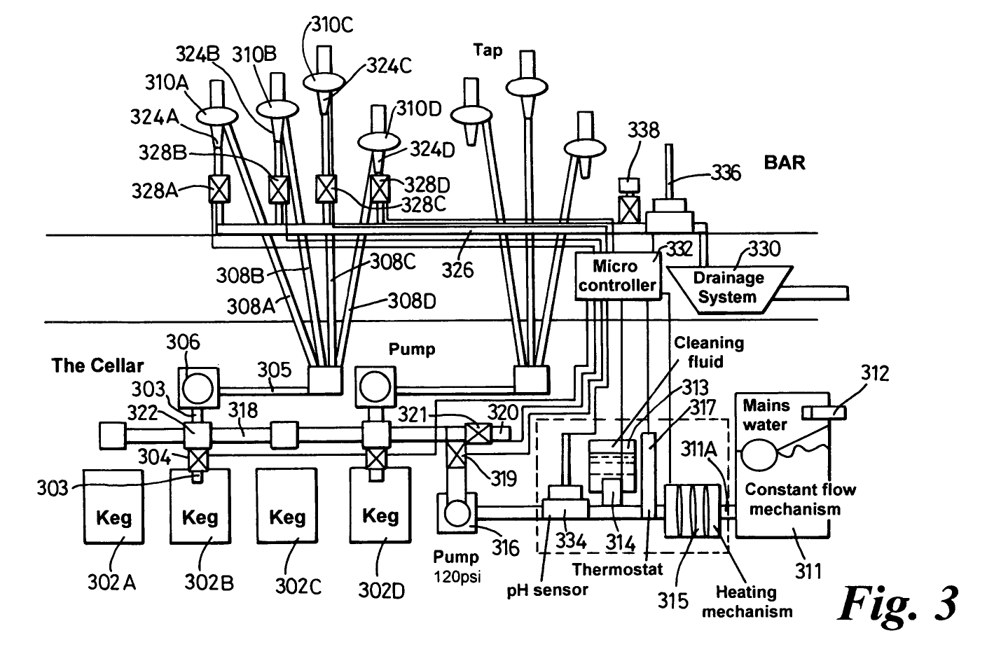

FIG. 3 illustrates schematically a first embodiment of the cleaning system installed in a first type of conventional beverage supply apparatus, and

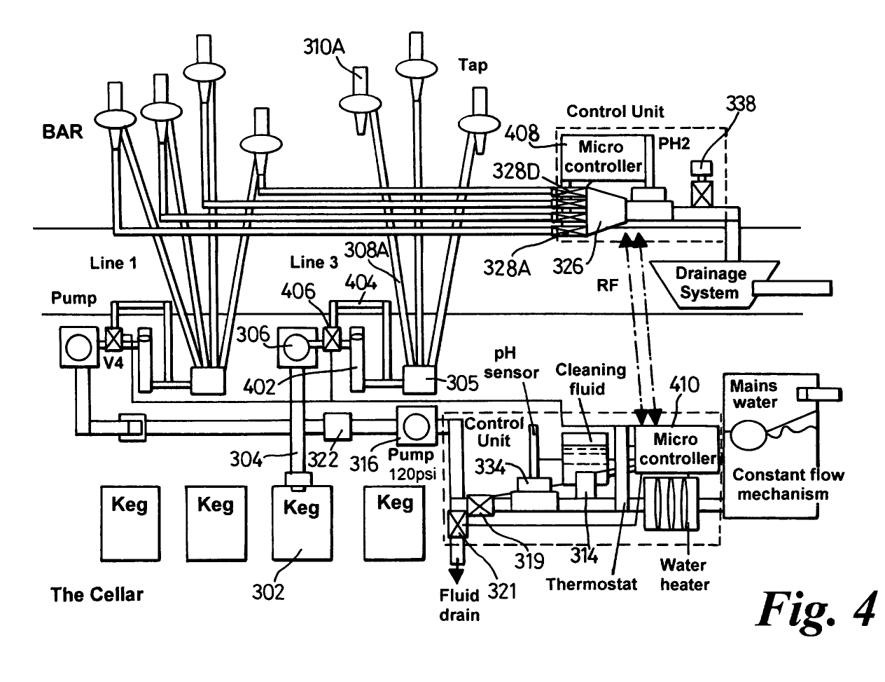

FIG. 4 illustrates schematically a further embodiment installed in another type of beverage supply apparatus.

Referring to FIG. 3, four conventional beverage containers/beer kegs 302A-302D are located in the cellar area of a catering establishment. Keg 302B is connected to a supply line 303. The flow of beer from the keg 302B into the line 303 can be controlled by a valve 304. The supply line 303 is connected to a pump 306 which, when the valve 304 is open, pumps beer from the keg 302B up through an adapter 305 that branches into four supply lines 308A-308D, the outlet end of each line being connected to a respective tap 310A-310D located in the bar area. In FIG. 3 keg 302D is also connected to a respective pump, a set of three supply lines and three respective taps. It will be appreciated that these and other further supply lines can be cleaned by the system but for the ease of description only the cleaning of the components attached to keg 302B will be described in detail herein. So far, the features described are substantially conventional and are used to deliver beer from the keg out through one of the taps.

The cleaning system attached to the beer delivery apparatus includes a container 311 which is connected to a mains water supply 312 by means of a constant flow (e.g. floating ball valve) mechanism. A conduit 311A leading from the container 311 is fitted with a heating device 315 and a thermostat 317. There is also a second container 313 that holds a cleaning agent in liquid form. A valve 314 is fitted to the conduit 311A, upstream of the heater 315 and thermostat 317. Opening the valve 314 brings the conduit 311A into flow communication with the second container 313. Thus, opening the valve 314 allows the cleaning agent in container 313 to be added to water from the container 311.

The conduit 311A then leads to a 120 psi pump 316 which can deliver fluid from the conduit 311A to a cleaning fluid line 318. A cleaning fluid delivery control valve 319 is fitted to the cleaning fluid supply line 318 upstream of the pump 316. A drainage conduit 320 can be brought into flow communication with the line 318 by opening a drainage valve 321.

A coupling 322 can bring the cleaning fluid line 318 into flow communication with the beverage supply lines. In some embodiments the coupling 322 is detachable and is connected to the apparatus before and after the cleaning operation. Thus, when the keg valve 304 is closed and the cleaning fluid delivery control valve 319 is open, the pump 316 can be used to deliver fluid from the conduit 311A through the cleaning fluid line 318 to the supply line 303, and via the pump 306, through the three supply lines 308A-308D to the taps 310A-310D.

In the embodiment of FIG. 3, the outlet of each tap 310A-310C is fitted with a respective tap connector 324A-324D. The other end of each tap connector 324A-324D is fitted with a respective outlet control valve 328A-328D. Opening one of the valves 328A-328D brings the associated tap connector into flow communication with a shared outlet conduit 326. The shared outlet conduit 326 leads to a drainage system 330, which will normally be the existing drainage system of the establishment, although a separate drainage system/container may be used.

It will be appreciated that the embodiment shown in FIG. 3 features tap connectors 324 that allow the cleaning system to be easily attached to an existing beverage supply apparatus. However, it will be understood that other configurations can be used, e.g. the outlet control valves can be fitted to or built into other parts of the supply lines, or as a complete unit (rather than the taps) to allow cleaning fluid running through the supply lines to collectively flow into an outlet conduit. Alternatively, the taps may be adapted so that they can be opened/closed by the controller. Such configurations can be built into new installations of beverage supply apparatus. In yet another alternative configuration, one outlet control device can control the flow of fluid out of more than one supply line.

The cleaning system includes a microprocessor controller 332 which is configured to execute a cleaning programme as described herein. The microprocessor controller 332 may be part of a computer system, a programmable logic controller with data acquisition capabilities or the like. The controller can have a display that can be used to show error or status messages, communicate with a PC through hard linking or through other communication techniques etc. The controller will typically include an array of buttons that the user can press to initiate the cleaning operation, etc.

The controller 332 is connected to a first sensor 334 which is located in the conduit 311A between the valve 314 and the pump 316. The sensor 334 is intended to monitor the concentration of the cleaning agent in the fluid passing through the conduit 311A to the pump 316. In one embodiment the sensor 334 comprises a pH electrode which returns an output signal to the controller 332, although it will be understood that alternative means of monitoring the concentration of cleaning agent in the fluid can be used, e.g. an optical sensors, capacitive, light frequency, or microscopic methods.

The controller 332 is also connected to a second sensor 336. The sensor 336 is intended to monitor the concentration of the cleaning agent in fluid flowing through the shared conduit 326. Again, the sensor 336 can be a pH-based sensor or any other suitable device. A filtered airflow valve 338 is also fitted to the shared conduit 326, downstream of the sensor 336.

The controller 332 can control the opening/closing of the keg valve 304, the filtered air valve 338, the cleaning fluid source valve 319, the drainage control valve 321, the cleaning agent supply valve 314 and the outlet control valves 328A-328D. These valves are typically solenoid valves. The controller 332 can also control the heater 315 (and in some cases pumps 316, 306) and receive output from the thermostat 317.

An example of the operation of the system under the control of the controller 332 will now be described. It will be appreciated that the order of some of the steps described herein can be changed and some of them could be repeated or omitted whilst still providing an effective method of for cleaning the supply lines.

At the start of the cleaning operation clean cold water from the tank 311 may be flushed through the system by means of pump 316 delivering it through the open valve 319, coupling 322, pump 306, lines 308A-308D to the taps 310A-310D so that the remaining beverage remaining in the line can be sold. This is usually done under the control of the controller 332 after the user has pressed an appropriate button to initiate the cleaning process.

Next, the user connects a respective tap connector 324A-324D to each tap 310A-310D connected to the lines that are to be cleaned and then opens the taps so that the flow of fluid out of each tap/line into the shared conduit 326 is controlled by the corresponding outlet control device 328. The user then presses an appropriate button on the controller which causes all of the outlet control valves 328A-328D to close.

The clean cold water from the container 311 is heated to a predetermined temperature, e.g. 50° C., by means of the controller 332 controlling the heating device 315 in accordance with output from the thermostat 317. The concentration of cleaning agent in the line 318 is kept substantially constant by the controller 332 whilst cleaning fluid is being delivered for the cleaning process. Convection currents in the heated water can help thoroughly mix water with a cleaning agent. The controller uses the output of pH sensor 334 to monitor the concentration of the cleaning agent in the fluid flowing through the conduit 311A (and thus also maintaining the cleaning agent concentration in downstream components such as line 318). The cleaning agent valve 314 is kept open by the controller 332 until the output of the sensor 334 outputs a pH value of 12.3.

It will be appreciated that the pH value of the cleaning fluid will depend upon various factors such as the type of cleaning agent being used. When the desired pH value is output by the sensor 334, the controller sends a signal to close the valve 314, but will open it again if the pH value output by sensor 314 deviates from 12.3 when the cleaning fluid is being delivered.

When the desired pH value is achieved the pump 316 is turned on (possibly through the sequence of a program or by the user pressing an appropriate button on the controller) and the cleaning fluid supply valve 319 is opened/closed at a frequency of 0.3 Hz, with a maximum pulse width of 3π/2 radians by the controller 332. The controller also opens/closes a first one of the outlet control valves 328A at three times the frequency of valve 319 with a maximum pulse width of π/2 radians, and a phase shift of π/2 radians, existing between the openings of the two valves. The cleaning fluid is pumped to all the upper supply lines 308A-308D but can only escape to the shared conduit 326 when the outlet control valve 328A is open. The growth and decay of fluid pressure within the supply lines can generate differential pressure waves of different phase and magnitude which can prove effective in cleaning the inner surfaces of the lines. It will be appreciated that the frequency/phase shift values given herein are exemplary only and experiments have shown that a wider range, e.g. a frequency in the range 0>f≦10 Hz and a phase shift between the angles of 0>θ<2π radians, can be effective. The motion of the cleaning fluid being pumped is also turbulent. The raised temperature of the cleaning fluid is such that restrictions in the lines can be broken down more easily. These features can further help clean the interior of the lines where yeast commonly grows.

As the cleaning fluid escapes via the valve 328A into the shared conduit 326, the pH of the fluid flowing through is measured by the sensor 336. When the controller 332 receives a signal from the sensor 336 indicating that the pH value of the fluid is 12.3 this is taken as indicating that the cleaning fluid has removed substantially all of the yeast within the line 308A and its associated tap 310A at least (as the presence of yeast causes the pH value and concentration of cleaning fluid to deviate from its supply pH value of 12.3) At this point the outlet control valve 328A is closed and one of the other outlet control valves 328 is opened. Normally, the outlet control valve which will be opened will be the one adjacent the previously open valve in a left-to-right order, although it will be appreciated that other sequences can be used.

In the specific example, the controller 332 then opens and closes the valve 319 at a frequency of 0.3 Hz, with a maximum pulse width of 3πr/2 radians, zero phase shift. The controller also opens and closes the valve 328B at a frequency of 0.9 Hz, and a maximum pulse with of π/2 radians, π/2 radians phase shift. Thus, cleaning fluid continues to be pumped through the lines, with some of the fluid escaping through the valve 328B when it is open into the shared conduit 326 until the pH detector 336 indicates that the pH value of the fluid in the conduit is around 12.3. When this pH value is returned the outlet control valve 328B is closed and the operation continues with the controller oscillating the opening of the outlet control valve of the ‘next’ supply line along with the cleaning fluid source valve 319. This process is repeated until all the lines/taps that are to be cleaned have been treated. All the outlet control valves 328A-328C is then opened.

In an alternative embodiment it is possible to open all valves 328A-328D and allow fluid to flow through all the lines simultaneously until the sensor 338 outputs a pre-determined value such as a pH of 10. This can save time in the subsequent cleaning process where each line is cleaned sequentially whilst the other lines are steeping and/or being agitated using the pressure wave technique described above.

The supply lines can then be flushed with cold clean water from the mains supply (i.e. without any cleaning agent being added via valve 314 and the heater 315 switched off). The water continues to be pumped by pump 316 through the lines until the pH detector 336 outputs that the fluid running through the shared conduit 326 has a neutral pH valve of 7, which indicates that substantially no cleaning fluid remains in the lines. At this point the user/controller can perform one of the following two options:

1) Valve 321 is opened to drain the water out of the system via drain conduit 320. The air filter valve 338 is opened to allow air to flow through the lines to the drainage 320, thereby drying the substantially contaminant-free lines. This occurs due to the fact that there is head pressure (or atmospheric pressure operating in the system). Therefore air or gas may be pushed through the system without the need for a pump. This will only allow the sellable beverage to flow through the system after cleaning without it being contaminated by any other fluid, and the first few pints are saved. This method also increases the flexibility of the system by allowing the cleaning process to be performed at virtually any time of day as little or no form of human intervention is required. Further, substantially no fluid that can affect product quality should remain in the lines after the cleaning.

2) If air or gas cannot flow through the system (as in the beverage supply apparatus of FIG. 4) then valve 304 is opened (or connected back to the beverage supply system by removing coupling 322) to allow beverage to flow behind the clean water in the system, which can be detected by the pH sensor 336 at the outlet conduit. When the pH of the element 336 rises to a predetermined level such as 6.6 then the controller 332 can cease the delivery of beverage in the system automatically by closing keg valve 304. Alternatively, one or more of the taps 310A-310D can be stopped manually when the user decides that the quality of beverage is up to a high enough standard.

The beverage supply apparatus shown in FIG. 4 is similar to that of FIG. 2. However, the components of the cleaning system further include an additional conduit indicated at 404 which can be attached before the cleaning process to bypass the ball and socket device 402 (i.e. to bring the pump 306 and the supply lines 308 (or adapter 305) into direct flow communication with each other). A valve 306 is opened to allow gas or fluid to flow through bypass section 404 without disturbing the fluid-only component 402.

Alternatively, if the component 402 can be locked so as to prevent the ball from sinking with the presence of gas or air in the cleaning process then the bypass system can be ignored and regarded as a normal section of line.

In the embodiment of FIG. 4 the tap connectors include longer conduits than those of FIG. 3 with the outlet control devices 328A-D being located at the end of the conduits remote from the taps. The outlet control devices are in flow communication with a funnel-shaped shared conduit 326 to which the sensor 336 is connected.

In FIG. 4 instead of having a single controller 332 as in FIG. 3 connected by wires to the various components, parts of the cleaning system (e.g. outlet control valves 328 and pH sensor 336) that are located in the bar area communicate with a first controller device 408, whilst the parts located in the cellar area (e.g. valves 406, 321, 319, and 314 as well as pH sensor 334) are connected to a second controller device 410. The two controller devices 408 and 410 can communicate by any suitable means such as radio frequency signals; a ground cable in an alternating current ring mains; conventional wiring or Bluetooth™ signals with the use of handshaking. This set-up can be easier to install than having a single controller linked by conventional wiring to several components located in both the bar and cellar areas.

The embodiments described above can result in the cleaning fluid being delivered until an accurate indication that contaminates such as yeast has been cleaned from the lines. This is an improvement over a conventional time-based system where there is no guarantee that all the contaminants have been removed even if the cleaning has been performed for the recommended duration. Thus, in the embodiments described the duration of the cleaning process is based on an indication of the effectiveness of the process derived from the substantially constant monitoring of fluid. Therefore, the process need only run for as long as it takes to produce an acceptable result. The embodiments can also save substantially all the beverages present in the line without it having to be wasted as in conventional systems, which can reduce costs. The system also offers increased flexibility over conventional systems as it requires little or no human intervention and so cleaning can be performed overnight or at other times without requiring constant attention from bar staff. The system can determine the failure of any components fail through the use of a potential divider system with voltage feedback and signal comparison to constantly monitor if all the components are functioning correctly. For example, if a signal is sent to a transistor to switch on a component then the resistance across the transistor and device will be low if the component is working correctly, otherwise it will be high. Therefore, monitoring the voltage drop across the transistor and the device will indicate whether the device is working correctly due to the current flow in the system. The controller can then operate system components on the feedback voltage results so that clean water is flushed to protect the existing system and the quality of the product.

Further, the use of the pH sensor 334, and 336, or any other fluid monitoring sensor means that the actual quantity of the cleaning agent remaining in the storage tank, and required can be determined, hence this saves excessive amounts of agent being used. The controller can show a warning message on its display to indicate that a new supply of cleaning agent is required.

It will be appreciated that components of the system can be added to existing beverage/foodstuff or other types of supply installations, or they may be an integral part of the system. It will also be appreciated that the system can be used for cleaning lines in other applications other than foodstuff/beverage supply and modifications to the program control, etc can be made to suit the requirements of the particular application.

1. A method of cleaning a plurality of supply lines, all or some of the lines having an outlet control device configurable to either allow or prevent fluid in the line flowing to a shared outlet conduit, the method including steps of:
setting the outlet control devices of one or more of the plurality of supply lines to allow fluid flow to the outlet conduit;
setting the outlet control devices of the remainder of the plurality of supply lines to prevent fluid from flowing to the outlet conduit;
delivering cleaning fluid to the plurality of supply lines such that the fluid passes into the outlet conduit via the one or more outlet control devices so set;
monitoring the concentration of cleaning fluid passing through the outlet conduit, and
ceasing the delivery of cleaning fluid when the concentration reaches a predetermined level.

2. A method according to claim 1, wherein during the cleaning fluid delivery step, cleaning fluid that does not pass into the outlet conduit is steeped and agitated within the supply lines to provide a cleaning action.

3. A method according to claim 1, wherein the steps of setting the outlet control devices, delivering the cleaning fluid and monitoring the concentration of cleaning fluid include:
a) setting the outlet control device of a first one of the plurality of supply lines to allow fluid flow to the outlet conduit;
b) setting the outlet control devices of the remaining lines to prevent fluid from flowing to the outlet conduit;
c) delivering cleaning fluid to the plurality of supply lines such that the fluid passes into the outlet conduit via the outlet control device of the first line;
d) monitoring the concentration of cleaning fluid passing through into the outlet conduit, and when the concentration reaches a predetermined level;
e) setting the outlet control device of the first line to prevent fluid from flowing to the outlet conduit, and
f) setting the outlet control device of a second one of the plurality of supply lines to allow fluid flow to the outlet conduit.

4. A method according to claim 3, wherein the steps a) to e) are repeated for all or some (normally adjacent) pairs of the plurality of supply lines.

5. A method according to claim 1, further including a step of draining the lines.

6. A method according to claim 1, wherein the step of delivering the cleaning fluid includes opening a valve that controls flow of cleaning fluid between a cleaning fluid source and the plurality of lines and pumping the fluid from the source to the supply lines.

7. A method according to claim 6, wherein the cleaning source valve is configured to allow cleaning fluid to flow into the lines periodically.

8. A method according to claim 1, wherein the outlet control devices comprise valves, with opening of the valves resulting in the fluid flowing into the outlet conduit.

9. A method according to claim 1, wherein the one or more outlet valves set to allow fluid to flow to the end of the conduit are opened after a valve of a cleaning fluid source is opened such that a phase shift exists between the openings of the valves.

10. A method according to claim 9, wherein the frequency of the opening of the valves is in the range of 0>f≦10 Hz.

11. A method according to claim 1, wherein the step of monitoring the concentration of the cleaning fluid includes analysing the pH of the fluid passing into the outlet conduit (326).

12. A method according to claim 11, wherein the fluid delivery is ceased if the pH of the fluid is detected to be substantially equivalent to the pH of the cleaning solution supplied at the start of the method.

13. A method according to claim 1, further including a step of draining at least some of the plurality of lines of any fluid before the cleaning fluid delivery step.

14. A method according to claim 1, further including a step of flushing the plurality of lines after ceasing the delivery of cleaning fluid.

15. A method according to claim 14, wherein the post-fluid delivery flushing step includes steps of:
delivering water to the plurality of supply lines such that the fluid passes into the outlet conduit via the one or more outlet devices so set;
monitoring the concentration of cleaning fluid passing into the outlet conduit, and ceasing the delivery of water when the concentration reaches a predetermined minimum level.

16. A method according to claim 1, wherein the cleaning fluid delivered is supplied from a container and the concentration of the cleaning fluid in the container is kept substantially constant by steps of:
adding a cleaning agent to water to produce a cleaning fluid;
monitoring the concentration of cleaning agent in the cleaning fluid, and
ceasing the adding of the cleaning agent when the concentration reaches a predetermined level.

17. A method according to claim 1, wherein the temperature of the cleaning fluid is raised to a temperature at which yeast and bacterial strains normally die, e.g. around 50° C.

18. A method according to claim 1, further including a step of modifying the one or more supply lines (308) so that they are in flow communication with a cleaning fluid source (318) instead of a normal source, e.g., a foodstuff or beverage source.

19. Fluid supply apparatus including:
a plurality of supply lines, each said line having an outlet control device configurable to either allow or prevent fluid in the line flowing to a shared outlet conduit;
a cleaning fluid source;
a controller which, in use, sets the outlet control devices of one or more of the plurality of supply lines;
a device for delivering cleaning fluid from the source to the plurality of supply lines, and
a device for monitoring the concentration of cleaning fluid passing through the outlet conduit,
wherein the controller uses output from the monitoring device to control the fluid delivered by the delivery device and the one or more outlet control devices.

20. Apparatus according to claim 19, wherein the cleaning fluid delivery device includes a pumping device and a device for controlling fluid flow between a cleaning fluid source and the plurality of supply lines.

21. Apparatus according to claim 20, wherein the outlet control devices and/or the cleaning fluid source flow control device comprise controllable valves such as solenoid valves.

22. Apparatus according to claim 19, wherein the outlet control devices include taps (e.g. bar taps) that have been modified or designed to be controlled by the controller (332).

23. Apparatus according to claim 19, wherein the cleaning fluid source includes a water source and a cleaning agent source and the apparatus further includes a device for mixing the cleaning agent and water.

24. Apparatus according to claim 19, further including a device (315) for heating the cleaning fluid.

25. Apparatus according to claim 19, wherein the outlet conduit comprises a drainage system or container.

26. Apparatus according to claim 19, wherein the plurality of supply lines branch from one or more downstream supply lines and the device for delivering cleaning fluid is in flow communication with the one or more downstream supply lines.

27. Apparatus according to claim 19, wherein the controller communicates with the monitoring device and/or the outlet control devices and/or the cleaning fluid delivery device by means of one or more of the following: Radio Frequency signals; a ground cable in an alternating current ring mains; conventional writing; Bluetooth™ signals or any other suitable communications system/network.

28. A cleaning kit for apparatus including a plurality of supply lines and a device for delivering cleaning fluid to the supply lines, the kit including:
one or more outlet control devices for use with respective one or more said supply lines, in use, each said outlet control device being set to either allow or prevent fluid in the line flowing to a shared outlet conduit;
a device for monitoring the concentration of cleaning fluid passing through the outlet conduit, and
a controller for setting each said outlet control device;
where, in use, the controller controls the fluid delivery device and the one or more outlet control devices in accordance with output from the monitoring device.

29. A kit according to claim 28, further including a device for heating the cleaning fluid.

30. A method of installing a cleaning kit for apparatus including a plurality of supply lines and a device for delivering cleaning fluid to the supply lines,
the method including steps of:
fitting one or more outlet control devices to a respective one or more said supply lines, in use each said outlet control device being set to either allow or prevent fluid in the line flowing to a shared outlet conduit;
fitting a device for the monitoring the concentration of cleaning fluid passing through the outlet conduit, fitting a controller which, in use, controls the fluid delivery device and the one or more outlet control devices in accordance with output from the monitoring device.

31. A beverage/foodstuff supply apparatus including a cleaning kit according to claim 28.
